(19) United States
(12) Patent Application Publication
(10) Pub. No.: US 2021/0291782 A1
(43) Pub. Date: Sep. 23, 2021

(54) VEHICLE THEFT PREVENTION DEVICE

(71) Applicant: AISIN SEIKI KABUSHIKI KAISHA, Kariya-shi (JP)

(72) Inventor: ZHI CAI, Kariya-shi (JP)

(73) Assignee: AISIN SEIKI KABUSHIKI KAISHA, Kariya-shi (JP)

(21) Appl. No.: 17/187,969

(22) Filed: Mar. 1, 2021

(30) Foreign Application Priority Data
Mar. 18, 2020 (JP) 2020-047511

(51) Int. Cl. B60R 25/0215

(52) U.S. Cl. CPC B60R 25/0215; B60R 25/02156; B60R 25/02153

(57) ABSTRACT

A vehicle theft prevention device includes a shaft, a tilt drive unit, and an expansion and contraction drive unit. A steering wheel that changes and operates a direction of a wheel in a vehicle is mounted on the shaft. The tilt drive unit adjusts an up-down angle of the shaft. The expansion and contraction drive unit adjusts a front-back position of the shaft. A lock mechanism is provided in which an engaging portion and an engaged portion that engage with each other and block rotation of the shaft when the shaft is at a preset tilt position and expansion-and-contraction position are arranged so as to be allocated to the shaft and the vehicle.

### CROSS REFERENCE TO RELATED APPLICATIONS

This application is based on and claims priority under 35 U.S.C. § 119 to Japanese Patent Application 2020-047511, filed on Mar. 18, 2020, the entire content of which is incorporated herein by reference.

### TECHNICAL FIELD

This disclosure generally relates to a vehicle theft prevention device that locks in such a way that a shaft of a steering wheel does not rotate during parking of a vehicle.

### BACKGROUND DISCUSSION

Such a vehicle theft prevention device is described in, for example, JP2019-156302A (Reference 1). This technique includes a lock mechanism that controls rotation of a steering shaft, a plurality of touch sensors installed in a steering wheel of a vehicle, and a control device that releases the lock mechanism on the basis of operation of the touch sensors, and performs control that enables rotation of the steering shaft.

Herein, for example, four capacitance type touch sensors are arranged in the steering wheel substantially at equal intervals. The touch sensors are each configured to be covered with a leather pad or the like in such a way that a position thereof cannot be visually perceived. At driving end and driving start of a vehicle, a driver touches each touch sensor in a previously stored order, then an action signal is sent out from a control unit, and a lock action and an unlock action are performed.

The steering shaft is provided with an electronic key, and a lock action and an unlock action are performed on the steering shaft by the action signal from the control device. However, a detailed structure of the electronic key is not described in Reference 1. Note that, at the driving end, it is possible to lock the steering shaft in conjunction with door lock of the vehicle.

Thus, the conventional vehicle theft prevention device is designed to acquire a theft prevention effect with a configuration in which only a driver recognizes a place or an operation method of the touch sensor.

However, in the conventional vehicle theft prevention device described above, the electronic key with which a lock action is performed on the steering shaft has to be newly attached. This electronic key needs an action member that engages with the steering shaft in order to prevent rotation of the steering shaft, and a mechanism that drives the action member.

The electronic key needs to securely stop rotation of the steering shaft, and therefore has to have predetermined strength. Thus, a size of the action member or the like of the electronic key has to be a certain size. Meanwhile, an installation space of the electronic key needs to be secured, but an accelerator pedal, a brake pedal, and the like are arranged in the vicinity of the steering shaft, and a shape and a size of the electronic key are limited. Moreover, a new wire needs to be laid between the steering wheel and the electronic key.

Thus, a device configuration becomes complicated in a vehicle theft prevention device that needs an additional drive device or the like. A drive state of the newly added device has to be soundly maintained as in other devices, and a management target in the whole vehicle increases. Manufacturing cost of the vehicle also rises accordingly.

A need thus exists for a vehicle theft prevention device which is not susceptible to the drawback mentioned above.

### SUMMARY

A vehicle theft prevention device according to this disclosure includes a shaft, a tilt drive unit, and an expansion and contraction drive unit. A steering wheel that changes and operates a direction of a wheel in a vehicle is mounted on the shaft. The tilt drive unit adjusts an up-down angle of the shaft. The expansion and contraction drive unit adjusts a front-back position of the shaft. A lock mechanism is provided in which an engaging portion and an engaged portion that engage with each other and block rotation of the shaft when the shaft is at a preset tilt position and expansion-and-contraction position are arranged so as to be allocated to the shaft and the vehicle.

### BRIEF DESCRIPTION OF THE DRAWINGS

The foregoing and additional features and characteristics of this disclosure will become more apparent from the following detailed description considered with the reference to the accompanying drawings, wherein:

FIGS. 1A and 1B are explanatory diagrams each illustrating a configuration and an action aspect of a vehicle theft prevention device according to a first embodiment;

FIGS. 2A and 2B are perspective views each illustrating details of a lock mechanism according to the first embodiment; and

FIG. 3 is a perspective view illustrating details of a lock mechanism according to a second embodiment.

### DETAILED DESCRIPTION

### First Embodiment

### (Overview)

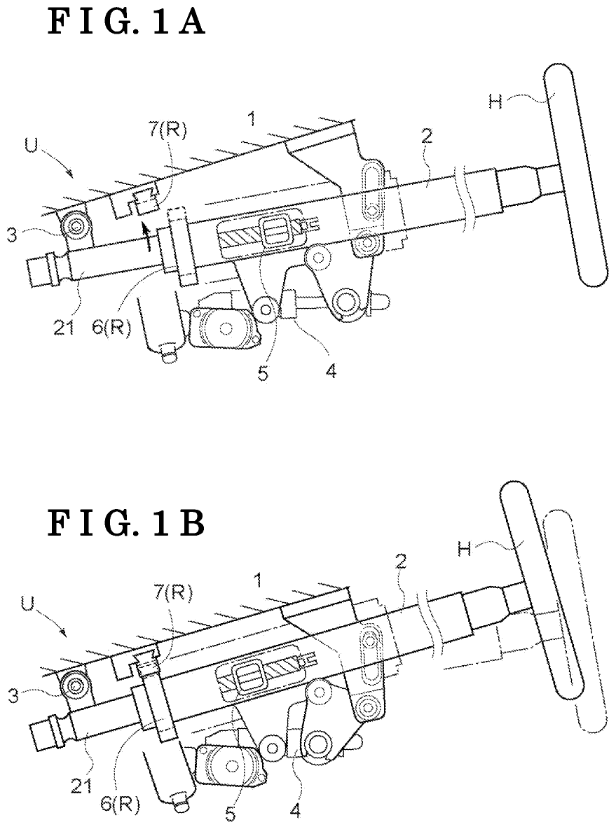

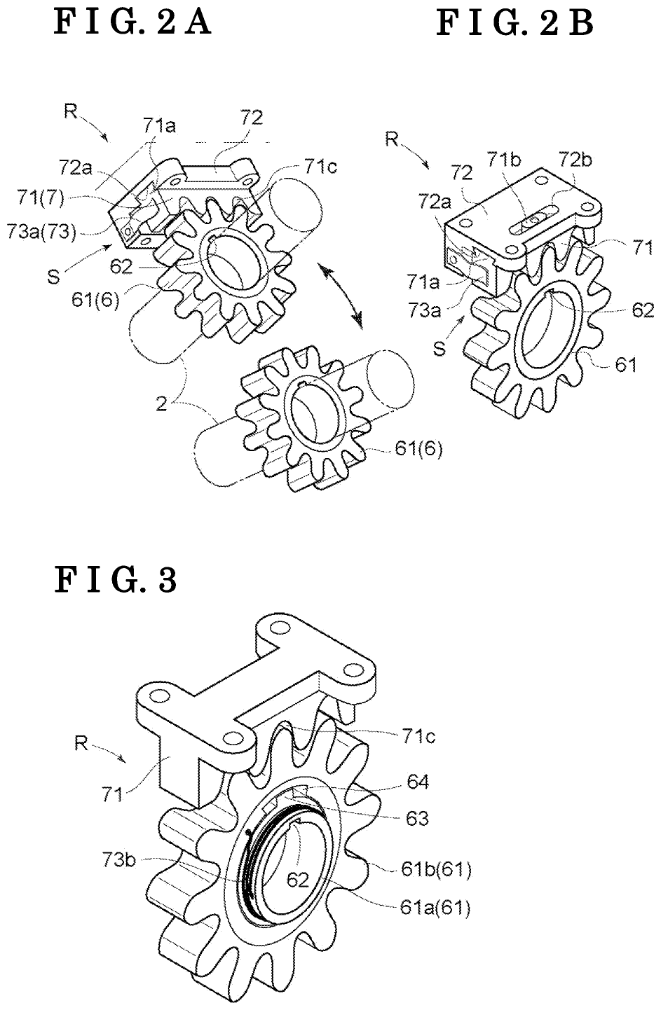

In a vehicle theft prevention device U according to this disclosure, a lock mechanism is configured by utilizing an attitude change of a shaft 2 on which a steering wheel H that changes and operates a direction of a wheel in a vehicle 1 is mounted. A first embodiment according to this disclosure is described with reference to FIGS. 1A, 1B, 2A and 2B.

FIGS. 1A and 1B illustrate a mechanism that can change a tilt attitude and an expansion-and-contraction position of the steering wheel H. An attitude of the shaft 2 is adjusted by a tilt drive unit 4 that changes an angle in an up-down direction on a pivot point 3, and an expansion and contraction drive unit 5 that changes a front-back position of the shaft 2 along a longitudinal direction of the shaft 2 relative to an inner shaft 21. FIG. 1A illustrates a state during driving where a lock mechanism R is disengaged, and FIG. 1B illustrates a state where the lock mechanism R is locked during parking or the like.

In the present embodiment, the lock mechanism R is provided, for example, across the shaft 2 and the vehicle 1. This lock mechanism R engages the vehicle 1 and the shaft 2 and regulates rotation of the shaft 2 when a relative position of the shaft 2 to the vehicle 1 is changed by the tilt drive unit 4 and the contracting drive unit 5, and the shaft 2 is at a preset tilt position and expansion-and-contraction position. The lock mechanism R is composed of, for example, an engaging portion 6 provided in the shaft 2 and an engaged portion 7 provided in the vehicle 1.

The engaging portion 6 is constituted of, for example, a gear 61, and is provided in a state of being externally inserted onto the pivot point 3 of the shaft 2 on the side of the steering wheel H. For example, a key groove 62 is provided on an inner side of the gear 61, and a key member (not illustrated) is engaged between the key groove 62 and the shaft 2 and fixed to the shaft 2. The engaging portion 6 is constituted of the gear 61 in order to enable the engaging portion 6 to be positively engaged with the engaged portion 7 no matter which rotation position of the steering wheel H is at during parking.

On the other hand, the engaged portion 7 is constituted of, for example, a rack 71 having a plurality of cutout portions 71c. For example, as illustrated in FIGS. 2A and 2B, a plurality of linearly provided teeth may be used. This engaged portion 7 is provided with a synchronization mechanism S with which the rack 71 is slidable relative to a base portion 72. Specifically, for example, a protruding portion 71a having a dovetail-groove-shaped cross-section is formed in the rack 71, and a relevant depressed portion 72a is formed in the base portion 72. In order to regulate a slide movement distance of the rack 71 relative to the base portion 72, a slide groove 72b is formed in a ceiling portion of the base portion 72. Meanwhile, a piece member 71b moving inside the slide groove 72b is mounted on an upper surface of the rack 71.

Furthermore, a resilient member 73 that defines a neutral position of the rack 71 is provided between the rack 71 and the base portion 72. Specifically, leaf springs 73a are respectively fixed to both end faces of the base portion 72, and an end face of the rack 71 is biased by an end of the leaf spring 73a. Thus, the synchronization mechanism S is configured with which the rack 71 is movable a predetermined distance in a longitudinal direction thereof with reference to the neutral position. Note that strength of the leaf springs 73a may be suitably set.

When the steering wheel H is not at the left-and-right neutral position during parking of the vehicle 1, the rack 71 is slide-movable at engagement with the gear 61. Thus, the gear 61 and the rack 71 can positively engage with each other even when positions of thereof are not coincident. Since the leaf springs 73a are provided, the gear 61 and the rack 71 contact each other without looseness, and an attitude of the steering wheel H in a lock state is stabilized. Since a slide movement distance of the rack 71 is limited by the protruding portion 71a and the depressed portion 72a, a lock function of the shaft 2 is positively exerted.

Note that without using the resilient member 73, the rack 71 may be configured to be able to freely move a predetermined distance relative to the base portion 72. In this case, when the steering wheel H is rotated leftward or rightward during parking, noise and oscillation of contact or separation between the gear 61 and the rack 71 are slightly produced, but the lock function is not affected.

In this way, the lock mechanism R is constituted by use of the tilt drive unit 4 and the contracting drive unit 5 that are already provided in the vehicle 1, thereby needing no provision of an additional drive unit in order to engage the engaging portion 6 and the engaged portion 7. Moreover, for example, the gear 61 and the rack 71 have an extremely simply structure, but are easy to secure strength. Manufacturing cost is low because of the simple configuration. With the vehicle theft prevention device U having this configuration, the vehicle theft prevention device U can be efficiently acquired without considerably changing a structure of a conventional steering column or the like.

(Action Aspect)

A lock action of the lock mechanism R is started by an off-operation of an ignition key. Specifically, the shaft 2 is moved to a highest part by the tilt drive unit 4, and at the same time, moved to a deepest portion by the contracting drive unit 5. Usually, this position is determined to be a lock position, so that the steering wheel H does not become an obstacle, and an action of getting on and off during driving becomes easy. Note that when it is desired to shorten a movement time of the shaft 2 while maintaining ease of the action of getting on and off, a lock position may be set to another position.

For example, when a function of storing a position of the steering wheel H for each driver is prepared, this function may be utilized for confirmation of the lock position. In other words, sensors provided in the tilt drive unit 4 and the contracting drive unit 5 are utilized in order to sense an attitude of the shaft 2. On the other hand, when no position storing function of the steering wheel H is prepared, the lock action may be finished by detecting heightening or the like of a load when the tilt drive unit 4 and the contracting drive unit 5 are each driven to a movement end point, and driving of a drive motor is forcibly stopped.

An unlock action when the vehicle 1 is run is started by an on-operation of an ignition key. Whether drive motors of the tilt drive unit 4 and the contracting drive unit 5 are sound is first confirmed by the on-operation. For example, a control unit (not illustrated) confirms soundness of a motor drive circuit by detecting a resistance value or the like of each unit of the drive circuit, and comparing the resistance value with a previously stored initial value. Current may be actually applied to the drive motor, and status of action start of the drive motor may be confirmed.

After normality of the drive motor is checked, a position of the shaft 2 is moved to the tilt position and the expansion-and-contraction position being associated with a driver. When there is no storing function for each driver, the shaft 2 may be moved to a preset basic position.

If an action failure or the like occurs in at least one of the drive motors, only the drive motor being in a sound state is activated. For example, when the tilt drive unit 4 is normal, a position of the shaft 2 is moved to a low position. Consequently, the gear 61 leaves from the rack 71 in a diametrical direction of the gear 61. When the contracting drive unit 5 is normal, the shaft 2 is moved to a side of the driver. Consequently, the gear 61 leaves from the rack 71 along a direction of a rotation shaft center of the gear 61.

Note that when a failure occurs in at least one of the tilt drive unit 4 and the contracting drive unit 5, a failure state is stored in the control unit, and the shaft 2 is set in such a way that the shaft 2 does not return to the lock position when the ignition key is turned off next. In other words, until this trouble is eliminated by repair or the like, a normal position adjustment action is enabled for only the sound drive unit, and a lock action during parking is not performed.

### Second Embodiment

As illustrated in FIG. 3, a synchronization mechanism S may be provided such that a rack 71 mounted on a vehicle 1 is immobile, and a gear 61 mounted on a shaft 2 rotates within a predetermined range. In this case, for example, the gear 61 is constituted of an inner ring portion 61a and an outer ring portion 61b that are relatively rotatable. The inner ring portion 61a is provided with an engaging protruding portion 63, and an engaging groove portion 64 that receives the engaging protruding portion 63 rotationally movably over a predetermined angle is formed in the outer ring portion 61b.

Furthermore, a spiral spring 73b is configured to be fixed across the inner ring portion 61a and the outer ring portion 61b so that the outer ring portion 61b is neutrally biased relative to the inner ring portion 61a. With this configuration as well, a simple and highly reliable vehicle theft prevention device U can be acquired.

### Other Embodiments

As an engaged portion 7 arranged in the vehicle 1, only one cutout portion 71c with which an engaging portion 6 such as a gear 61 engages may be formed instead of the rack 71. In this case, an interval of teeth of the gear 61 and a shape of the cutout portion 71c are set in such a way that at least one tooth of the gear 61 engages with the cutout portion 71c regardless of a rotation phase of the shaft 2. A tip shape of the tooth of the gear 61 is configured to be slightly sharpened in such a way as to positively engage with the cutout portion 71c. Note that in this configuration as well, a synchronization mechanism S is preferably prepared in the cutout portion 71c.

A vehicle theft prevention device according to this disclosure is widely applicable to a vehicle including a tilt drive unit and an expansion and contraction drive unit with regard to a shaft of a steering wheel.

A vehicle theft prevention device according to this disclosure includes a shaft, a tilt drive unit, and an expansion and contraction drive unit. A steering wheel that changes and operates a direction of a wheel in a vehicle is mounted on the shaft. The tilt drive unit adjusts an up-down angle of the shaft. The expansion and contraction drive unit adjusts a front-back position of the shaft. A lock mechanism is provided in which an engaging portion and an engaged portion that engage with each other and block rotation of the shaft when the shaft is at a preset tilt position and expansion-and-contraction position are arranged so as to be allocated to the shaft and the vehicle.

With this configuration including the lock mechanism using the tilt drive unit and the expansion and contraction drive unit that are already provided in the vehicle, no additional drive unit needs to be provided in order to engage the engaging portion and the engaged portion. Thus, a vehicle theft prevention device can be acquired without considerably changing a conventional steering structure.

Moreover, when a moving member that engages with a shaft is attached in order to block rotation of the shaft as in a conventional technique, strength of each member constituting the lock mechanism is insufficiently maintained due to limitation of a size of a member related to movement or the like. However, when the engaging portion provided in the shaft is engaged with the engaged portion provided in the vehicle as in this configuration, the engaging portion and the engaged portion can both have simple and high-strength configurations, and a vehicle theft prevention device with high durability can be acquired.

The vehicle theft prevention device according to this disclosure may be configured in such a way that a cutout portion with which the engaging portion engages is formed in the engaged portion arranged in the vehicle, and the cutout portion can be open in both a direction toward the steering wheel along a longitudinal direction of the shaft and a diametrical direction of the shaft in a state where the engaging portion and the engaged portion engage with each other.

With this configuration, the engaging portion and the engaged portion are disengaged from each other by driving of either one of the tilt drive unit and the expansion and contraction drive unit. Thus, even when a trouble occurs in the tilt drive unit or the expansion and contraction drive unit, running of the vehicle is possible, and early recovery from the trouble can be attained.

The vehicle theft prevention device according to this disclosure may be provided with a synchronization mechanism that engages the engaging portion and the engaged portion regardless of a rotation phase of the engaging portion being determined on the basis of a rotation phase of the shaft.

With this configuration, for example, the engaging portion and the engaged portion positively engage with each other no matter which rotation phase the shaft is in during parking, and a lock mechanism of the steering wheel can be functioned.

In the vehicle theft prevention device according to this disclosure, the engaging portion may be a gear externally inserted onto the shaft, the engaged portion may be a rack, and a resilient member that maintains a neutral position of the gear or the rack may be provided as the synchronization mechanism in at least one of a mounting portion of the gear to the shaft or a mounting portion of the rack to the vehicle.

With this configuration, even when a phase of the gear resulting from a rotation phase of the shaft is not proper for a position of the rack, the position of the rack moves to a position adapted to the phase of the gear against biasing force of the resilient member as the gear is pressed to the rack. Thus, a meshing state between the gear and the rack with predetermined depth is acquired. Since the gear and the rack contact each other without looseness owing to the biasing force of the resilient member, looseness of the shaft does not occur during parking of the vehicle. Thus, a vehicle theft prevention device with a good feel can be acquired.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A vehicle theft prevention device comprising:
a shaft on which a steering wheel that changes and operates a direction of a wheel in a vehicle is mounted;
a tilt drive unit that adjusts an up-down angle of the shaft; and
an expansion and contraction drive unit that adjusts a front-back position of the shaft, wherein
a lock mechanism is provided in which an engaging portion and an engaged portion that engage with each other and block rotation of the shaft when the shaft is at a preset tilt position and expansion-and-contraction position are arranged so as to be allocated to the shaft and the vehicle.

2. The vehicle theft prevention device according to claim 1, wherein
a cutout portion with which the engaging portion engages is formed in the engaged portion arranged in the vehicle, and
the cutout portion is configured to be open in both a direction toward the steering wheel along a longitudinal direction of the shaft and a diametrical direction of the shaft in a state where the engaging portion and the engaged portion engage with each other.

3. The vehicle theft prevention device according to claim 1, further comprising a synchronization mechanism that engages the engaging portion and the engaged portion regardless of a rotation phase of the engaging portion being determined based on a rotation phase of the shaft.

4. The vehicle theft prevention device according to claim 3, wherein the engaging portion is a gear externally inserted onto the shaft, the engaged portion is a rack, and a resilient member that maintains a neutral position of the gear or the rack is provided as the synchronization mechanism in at least one of a mounting portion of the gear to the shaft or a mounting portion of the rack to the vehicle.
